(19) United States
(12) Patent Application Publication
(10) Pub. No.: US 2004/0124148 A1
(43) Pub. Date: Jul. 1, 2004

(54) High pressure reverse osmosis housing

(76) Inventor: Santo Bozzo, Toronto (CA)

Correspondence Address: Kevin D. McCarthy, Roach Brown McCarthy & Gruber, P.C., 1620 Liberty Building, 420 Main Street, Buffalo, NY, 14202, US

(21) Appl. No.: 10/331,803

(22) Filed: Dec. 30, 2002

(51) Int. Cl. B01D 61/02; B01D 61/08

(52) U.S. Cl. 210/652; 210/321.6

(57) ABSTRACT

The present invention is directed to a reverse osmosis membrane housing. The housing has a pressurizable cylindrical central pipe having a membrane opening end and an integral bottom end, an o-ring and a cap. The integral bottom end has at least a purified fluid outlet and somewhere on the cylindrical central pipe is a waste outlet. The waste outlet and the purified fluid outlet extend away from the pressurizable cylindrical central pipe. A ferrule extends from the membrane opening, and has a first alignment device to secure the o-ring in a desired position on the ferrule. The cap has a distal end and a proximal end. The proximal end has second alignment device to secure the o-ring in a desired position on the cap, while the distal end has an inlet port so a fluid can flow through the inlet port. Once the fluid is within the housing it can take two paths. The first path is into a reverse osmosis membrane positioned in the pressurizable cylindrical central pipe and to the purified fluid outlet. The other path is used if the fluid cannot penetrate into the reverse osmosis membrane positioned into the pressurizable cylindrical central pipe, thereby the fluid goes through the waste outlet.

### FIELD OF THE INVENTION

The present invention is directed to a housing for a reverse osmosis membrane that is used in a reverse osmosis water purification system.

### BACKGROUND OF THE INVENTION

Applicant admits there are numerous types of housings for a reverse osmosis membrane. Each of these numerous types of housings is designed to receive a certain standardized reverse osmosis membrane for particular applications. Examples of such housings are-set forth in U.S. Pat. No. 3,400,825 (Shippey); U.S Pat. No. 3,493,496 (Bray et al.); U.S. Pat. No. 3,542,203 (Hancock et al); U.S. Pat. No. 5,002,668 (Spranger); U.S. Pat. No. 5,595,651 (Pavel); and U.S. Pat. No. 6,007,710 (Pavel).

Pavel in the '651 patent discloses many of the problems of prior housings. In particular, Pavel wrote the following:

“General Construction of Housings for Reverse Osmosis Membranes, or Membrane Housings

Housings for reverse osmosis membranes, or membrane housings, are commonly made of various combinations of three materials. Each material used must be essentially inert to, and uncorrupted or corroded by, the liquids with which it comes into contact during the reverse osmosis process. Because the liquids at the exterior of the membrane within the housing are, in accordance with the principles of reverse osmosis, necessarily at a considerable pressure, the material of the housing must have considerable structural strength.

Stainless steel is commonly used for the highest pressure applications, typically for pressures in the range over eight hundred pounds per square inch (>800 lbs./inch²), and typically less than one thousand pounds per square inch (<1000 lbs./inch²). Filament wound fiberglass may also be used for the same high pressures. Finally, thermoplastic, and most commonly polyvinyl chloride, or PVC, is used for low osmotic pressures up to approximately two hundred pounds per square inch (<200 lbs./inch²).

An osmosis membrane is commonly shaped as an elongate cylinder, and so also is the shape of the housing holding the cylindrical membrane. Low pressure membranes are commonly available in sizes 4″×14″, 4″×21″, 4″×40″, and 2 @ 4″×40″ where 4″ is the outside diameter and the 14″, 21″, or 40″ is the length. The inside diameter, or bore diameter, of the osmosis membrane is commonly about one-half inch (½″), terminating at both ends of the bore in a short, three-quarter inch (¾″) pipe stub. The principle of the use of the osmotic membrane is that an unpurified and pressurized inlet fluid is fed into the membrane along its one end while a concentrate fluid is withdrawn from the exterior surface of the membrane at the opposite end. Such portion of the pressurized fluid as penetrates through the membrane to its central bore exhibits a greatly reduced pressure, and is drawn off from either, or both, ends of this central bore as the purified, or product, fluid.

The housing that fits about the osmotic membrane accordingly has, for a one common type of membranes, an interior diameter of four inches (4″). The housing is of a length suits the enclosure of the full length of the membranes, which are commonly of lengths 14″, 21″ or 40″. A housing will sometimes enclose two membranes such as, for example, 2 @ 4″.times.40″.

Problems With the Construction and Use of Membrane Housings

Membrane housings must have removable end sections, or caps, in order that access may be obtained to the contained filter for filter replacement. The opening to the filter must be of a diameter as great as is the filter itself, or commonly 4″. When the housing and its contained filter are in use in a reverse osmosis system, the fluid inside the housing is pressurized, commonly at up to two hundred and thirty pounds per square inch (230 P.S.I.). The force exerted by this pressure against a circular plug of four inch outside diameter (4″ O.D.) and approximately twenty-five square inches (25 in²) area is on the order of five thousand seven hundred and fifty pounds (5,750 lbs.), or two and seven-eighths tons (2.875 tons) of force.

One common construction of and end plug, or cap, is applied to a reverse osmosis membrane housing that has, as its central structural element, a thick and robust custom-extrusion cylindrical pipe, commonly of PVC. The PVC pipe is commonly of four inch internal diameter (4″ I.D.) with a twenty-six hundredths inch (0.26″) wall thickness. A circular plug of four inches outside diameter (4″ O.D.) and a typical thickness of one inch (1″) is retained within the pipe at a position typically one and one-half inches (1½″) from the end of the pipe. The circular plug is typically so maintained by removable pins or dowels, typically two in number made from quarter inch (¼″) stainless steel rod, that extend through opposing (¼″) holes in the wall of the pipe and transversely across the (4″) bore of the pipe. The two transverse pins are typically spaced parallel at a separation from each other of two and one-quarter inches (2¼″), and are spaced each one at about one-half inch (½″) maximum separation from that interior sidewall of the pipe to which it is most closely adjacent.

The one inch (1″) thick circular plug presents circumferential channels or grooves—typically two in number—in which are typically placed neoprene rubber “O”' rings to serve as sealing gaskets. Fluid flow access to the filter within the pipe, and the housing, is through ports in the cap. A first port in the cap is typically located midway between the center and the rim, and permits fluid flow access to the filter for purposes (as the connection dictates) of either (i) unpurified input or (ii) concentrate output. An optional second port in the cap is centrally located and serves, when opened, to permit flow communication with the axial bore of the filter for the purpose of retrieving the purified, product, output fluid.

There are several problems presented with this construction. This first, and most dire, problem is that the entire assembly is prone to catastrophic failure in use, hazarding the severe flooding of the premises in which a reverse osmosis system is installed. Because the four holes in the sidewall of the PVC pipe into which the stainless steel pins are inserted serve to weaken the pipe at this location, an exterior surround band, also typically of stainless steel, is use to surround the pipe and to also engage the ends of the stainless steel retaining pins. No substantial redistribution of the high local specific forces at the four pin holes may be accomplished unless, and until, the surround band is affixed to the circumference of the pipe. The surround band is so typically affixed by glue and/or by its complimentary fit into a shallow exterior circumferential groove to the pipe. Because the location of the (i) four pin holes, or (ii) the shallow exterior circumferential groove, are the structurally weakest points of the PVC pipe, the pipe typically fails by completely rupturing into two separate pieces at a one of these locations.

Another problem is presented with accessibility to the filter. The stainless steel pins are prone to contamination, and must typically be driven from their seated positions (holding in the end plug, and filter) by use of a hammer and drift punch, often in tight quarters. Reinsertion of the stainless steel retaining pins is equally cumbersome, and normally requires effort to align the pins into their transverse holes, and hammering.

Still another problem is presented with the location of the “O” ring seals to the rim of the circular plug. Although the pressure against these rings permits fluid-tight sealing, it is clear that the “O”-rings are, as seated within their invariant channels or grooves at the rim of the plug, not in compression between any two complimentary surfaces, but only as between one surface (a side of the channel, or groove, at the rim of the plug) an the pressurized fluid itself. This is an awkward use of a seal, or gasket, best and most reliably used in compression between two solid surfaces of complimentary contour. This awkwardness may be why manufacturers of prior art osmosis membrane housings often advertise and promote “double seals”, meaning two “O” rings per sealed channel per plug. Logically, if a seal was properly deployed then one such should suffice. (The present invention will prove to have redundant, dual, seals in one location only, which location is not equivalent to the location now discussed. The use of redundant, or dual, seals in the preferred embodiment of the present invention may considered to be as much for market acceptance, and user emotional comfort, as for any practical utility or necessity.)

A third problem is presented with the location of the flow connections at the plug which is seated well below the end of the pipe. It will be recalled that there is an inlet flow connection at one end of the housing for channeling unpurified, inlet, fluid into contact with the exterior surface of the osmosis membrane at a one end thereof. Likewise, there is a first outlet flow connection at the other end of the housing for channeling the waste, concentrate, fluid away from the osmosis membrane at its other end. Finally, there is a second outlet flow connection at one, or at both, ends of the membrane's central bore by which connection(s) the purified, product, fluid is extracted. In the prior art all these flow connections are through the plugs at each end. Logically, and in actual real-world use, less cumbersome movement of plumbing connecting to the housing would be required if at least some of the flow connections were to, and through, the cylindrical sidewalls of the housing as opposed to being through its end plugs.”

### BRIEF DESCRIPTION OF THE FIGURES

FIG. 1 is an exploded view of the present invention.

FIG. 2 is a cross-sectional view of FIG. 1 taken along the lines 2-2.

FIG. 3 is a view of FIG. 1 taken along the lines 3-3.

FIG. 4 is a side view of the o-ring of FIG. 1.

FIG. 5 is a view of FIG. 1 taken along the lines 5-5.

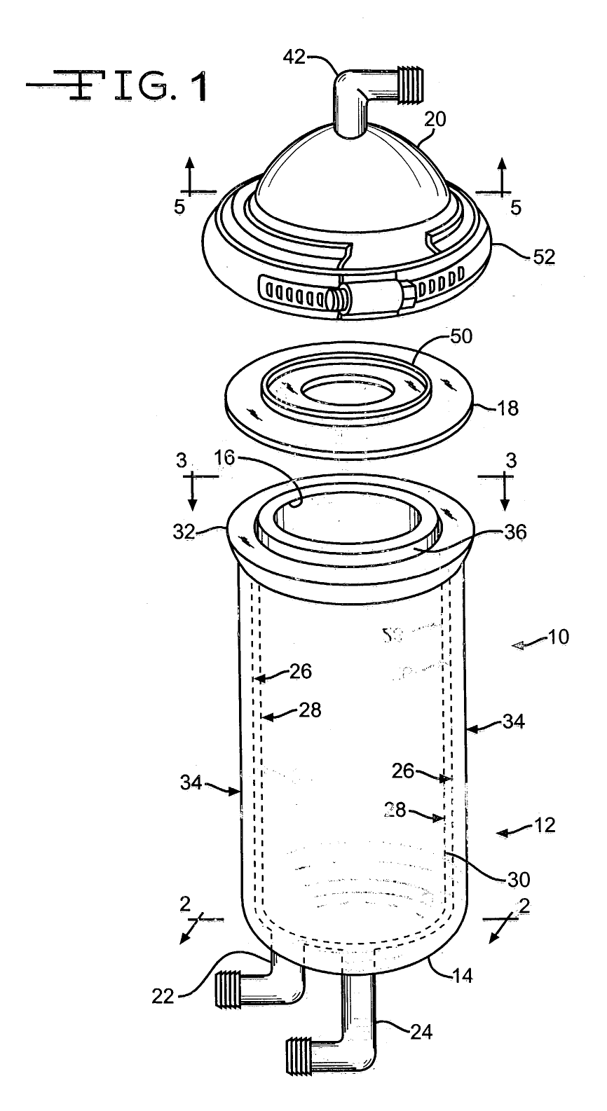

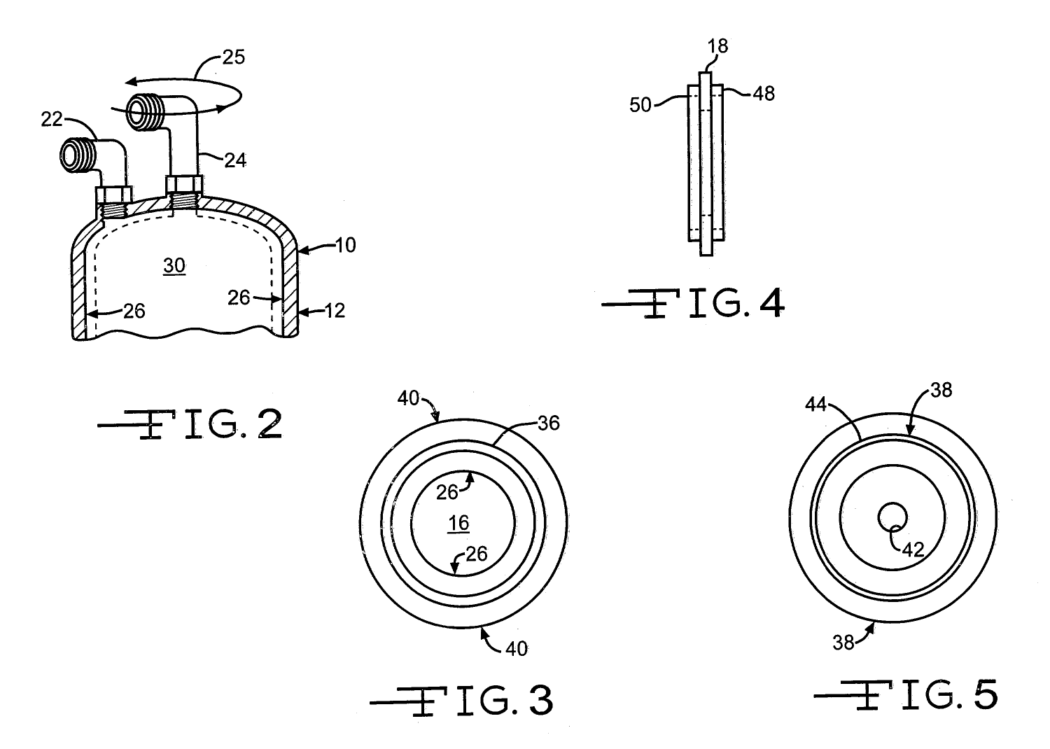

### SUMMARY OF THE INVENTION

The present invention is directed to a reverse osmosis membrane housing. The housing has a pressurizable cylindrical central pipe having a membrane opening end and an integral bottom end, an o-ring and a cap. The integral bottom end has at least a purified fluid outlet and somewhere on the cylindrical central pipe is a waste outlet. The waste outlet and the purified fluid outlet extend away from the pressurizable cylindrical central pipe. A ferrule extends from the membrane opening, and has a first alignment device to secure the o-ring in a desired position on the ferrule. The cap has a distal end and a proximal end. The proximal end has second alignment device to secure the o-ring in a desired position on the cap, while the distal end has an inlet port so a fluid can flow through the inlet port. Once the fluid is within the housing it can take two paths. The first path is into a reverse osmosis membrane positioned in the pressurizable cylindrical central pipe and to the purified fluid outlet. The other path is used if the fluid cannot penetrate into the reverse osmosis membrane positioned into the pressurizable cylindrical central pipe, thereby the fluid goes through the waste outlet.

### DETAILED DESCRIPTION OF THE INVENTION

The present invention is directed toward a stainless steel membrane housing 10 having (a) a cylindrical base 12, (b) an o-ring 18, and (c) a cap 20. The cylindrical base 12 has an integral bottom 14 and a membrane opening 16 opposite the bottom 14.

The bottom 14 has two fluid outlets extending therefrom. The two fluid outlets are a waste port 22 and a purified port 24. Neither waste port 22 nor purified port 24 have an o-ring apparatus to retain the fluid within the housing 10; Instead both ports 22, 24 are integral extensions from the bottom 14 extending away from the housing 10. In a preferred embodiment, purified port 24 is rotatable (arrow 25 in FIG. 2) so it can be easily positioned to a desired location.

The membrane opening 16 and the cylinder base 12 have an inner diameter 26 equal to or greater than an outer diameter 28 of a conventional reverse osmosis membrane 30 (not claimed) that is received within the housing 10. The membrane opening 16 also has a ferrule 32 extending beyond an outer diameter 34 of the cylinder base 12. Opposite the direction of the cylinder base 12, the ferrule 32 has a groove 36 therein.

The cap 20 has (a) an outer diameter 38 at least equal to the outer diameter 40 of the ferrule 32, (b) an inlet port 42 integrally extending from the cap 20 and away from the housing 10, and (b) a groove 44 therein.

Between the cap 20 and the ferrule 32 is the o-ring 18 having extensions 48, 50 that correspond to the grooves 36, 44 in the ferrule 32 and the cap 20, respectively.

To retain the cap 20 to the cylinder base 12, the present invention has a heavy duty hand-tightenable clamp 52.

When comparing the present invention to a conventional housing for reverse osmosis, the present invention eliminates one open end of a cylinder base, two o-rings, one end cap, two pins of conventional housings for reverse osmosis devices. The present housing will be seen to be generally concerned with an entire re-engineering of a reverse osmosis membrane housing so that (i) the housing is constructed entirely of stainless steel and is (ii) easy and quick to assemble about an enclosed membrane by hand and totally without tools, while (iii) exhibiting great strength and reliability. An example of this great strength and reliability is that that the present invention, which is designed for residential use, is capable of withstanding pressures equal to or about 600 psi and being rated for a quarter of that psi which is about 150 psi.

Alternatively, items 36, 44 of both base 12 and cap 20 can become extensions that fit into corresponding grooves 50,48 of o-ring 18. In addition, the o-ring 18 can have an extension and a groove that correspond with a particular base 12 or cap 20.

While the present invention has been particularly described in connection with certain specific embodiments thereof, it is to be understood that this is by way of illustration and not limitation, and the scope of the appended claims should be construed as broadly as the prior art will permit.

We claim:

1. A reverse osmosis membrane housing comprising
a pressurizable cylindrical central pipe having a membrane opening end and an integral bottom end;
the integral bottom end has at least a waste outlet and a purified fluid outlet, the waste outlet and purified fluid outlet extend away from the pressurizable cylindrical central pipe;
a ferrule extending from the membrane opening, the ferrule has a first alignment device to secure an o-ring in a desired position on the ferrule;
a cap has a distal end and a proximal end, the proximal end has second alignment device to secure the o-ring in a desired position on the cap, the distal end has an inlet port so a fluid can flow through the inlet port and (a) into a reverse osmosis membrane positioned in the pressurizable cylindrical central pipe and to the purified fluid outlet, or (b) if the fluid cannot penetrate into the reverse osmosis membrane positioned into the pressurizable cylindrical central pipe then the fluid goes through the waste outlet.

2. The housing of claim 1 wherein the o-ring has two corresponding alignment devices on each major surface of the o-ring for the first and second alignment device.

3. The housing of claim 1 wherein the first and second alignment devices are each a groove.

4. The housing of claim 1 wherein the first and second alignment devices are different and selected from the group consisting of a groove and a protrusion.

5. The housing of claim 2 wherein the corresponding alignment devices of the o-ring are selected from the group consisting of a groove or a protrusion.

6. The housing of claim 1 wherein the purified fluid outlet is rotatable.

7. The housing of claim 1 wherein the cap, the o-ring, and the ferrule of the cylindrical central pipe are secured together by a clamp.

8. The housing of claim 7 wherein the clamp can be securely attached without using tools.

9. The housing of claim 1 wherein the housing is made of stainless steel.

10. The housing of claim 1 wherein the housing is used for residential purposes.

11. The housing of claim 1 wherein the o-ring is the only o-ring used in the housing.

12. A reverse osmosis membrane housing comprising
a pressurizable stainless steel cylindrical central pipe having a membrane opening end and an integral bottom end;
the integral bottom end has at least a purified fluid outlet and the cylindrical central pipe has a waste outlet, the waste outlet and purified fluid outlet extend away from the pressurizable cylindrical central pipe;
a ferrule extending from the membrane opening, the ferrule has a first alignment device to secure an o-ring, the only o-ring used in the housing, in a desired position on the ferrule;
a cap has a distal end and a proximal end, the proximal end has second alignment device to secure the o-ring in a desired position on the cap, the distal end has an inlet port so a fluid can flow through the inlet port and (a) into a reverse osmosis membrane positioned in the pressurizable cylindrical central pipe and to the purified fluid outlet, or (b) if the fluid cannot penetrate into the reverse osmosis membrane positioned into the pressurizable cylindrical central pipe then the fluid goes through the waste outlet.

13. The housing of claim 12 wherein the o-ring has two corresponding alignment devices on each major surface of the o-ring for the first and second alignment device.

14. The housing of claim 12 wherein the first and second alignment devices are the same and selected from the group consisting of a groove and a protrusion.

15. The housing of claim 12 wherein the first and second alignment devices are different and selected from the group consisting of a groove and a protrusion.

16. The housing of claim 13 wherein the corresponding alignment devices of the o-ring are selected from the group consisting of a groove or a protrusion.

17. The housing of claim 12 wherein the purified fluid outlet is rotatable.

18. The housing of claim 12 wherein the cap, the o-ring, and the ferrule of the cylinder base are secured together by a clamp that does not require tools to tighten or loosen the clamp.

19. The housing of claim 12 wherein the housing is used for residential purposes.

20. A method of using a reverse osmosis membrane housing comprising
inserting a reverse osmosis membrane into a housing having (a) a pressurizable cylindrical central pipe having a membrane opening end and an integral bottom end; (b) the integral bottom end has at least a waste outlet and a purified fluid outlet, the waste outlet and purified fluid outlet extend away from the pressurizable cylindrical central pipe; (c) a ferrule extending from the membrane opening, the ferrule has a first alignment device to secure an o-ring in a desired position on the ferrule; and (d) a cap having a distal end and a proximal end, the proximal end has second alignment device to secure the o-ring in a desired position on the cap, the distal end has an inlet port;
allowing a fluid to flow through the inlet port and (a) into a reverse osmosis membrane positioned in the pressurizable cylindrical central pipe and to the purified fluid outlet, or (b) if the fluid cannot penetrate into the reverse osmosis membrane positioned into the pressurizable cylindrical central pipe and to the waste outlet.
